(19) United States
(12) Patent Application Publication
(10) Pub. No.: US 2018/0159282 A1
(43) Pub. Date: Jun. 7, 2018

(54) Extension cords, including plug and connector with improved indicator lights, and related methods

(71) Applicant: Prime Wire & Cable, Inc., La Jolla, CA (US)

(72) Inventors: Joe Ferlauto, Orange, CA (US); Bill Ferlauto, Mooresville, NC (US); Jeff Millar-Sax, Yucaipa, CA (US)

(21) Appl. No.: 15/828,261

(22) Filed: Nov. 30, 2017

Related U.S. Application Data
(60) Provisional application No. 62/428,490, filed on Nov. 30, 2016.

(51) Int. Cl. H01R 13/717; H01R 13/66; H01R 24/22

(52) U.S. Cl. CPC H01R 13/7175; H01R 24/22; H01R 13/6683

(57) ABSTRACT

Disclosed is an flexible extension cord with a power indicator in the female receptacle and a ground continuity indicator in the male plug.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND AN INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of extension cords. More specifically, the described subject matter is in the field of extension cords with ground and/or power indicator lighting effects.

### Background of the Invention

A typical extension cord is a length of flexible power cable with a male electrical connector (e.g., plug) on one end and a female electrical connector (e.g., socket) on the other end. Operably, extension cords provide a temporary and extended hard or wired connection between a power source and an electric device. Many cords are not adequately flexible and, as a result, cannot be easily handled when in use and easily wrapped when stored. Sometimes, cords include a power indicator light so that a user can safely and easily determine whether the cord is live (i.e., hot) with electricity, but use of ordinary dim lightbulbs fails to provide an adequate indication of light in most cases. Also, it is important to identify whether a cord is properly grounded prior to use because plugging a grounded male plug of an electronic device into an ungrounded female connector of a live/hot extension cord can be dangerous.

### SUMMARY OF THE INVENTION

In view of the foregoing, an object of this specification is to disclose an flexible extension cord with a power indicator in the female receptacle and a ground continuity indicator in the male receptacle.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1A is a side view of an extension cord 1000 with a male plug 1100 on one end and a female connector 1200 on the other end; and,

FIG. 1B is a top view of an alternate embodiment of an extension cord 2000 with female connector 2200 at one end with a plurality of sockets;

FIG. 2 is a cross section of the extension cord 1000;

FIG. 3 is a side view of the male plug 1100;

FIG. 4 is a front view of the male plug 1100;

FIG. 5 is a top view of the male plug 1100;

FIG. 6 is a cross section of the male plug 1100 with pre-mold 1140;

FIG. 7 is a schematic of the wiring of the male plug 1100 with ground continuity light;

FIG. 8 is a side view of the female connector 1200;

FIG. 9 is a front view of the female connector 1200;

FIG. 10 is a top view of the female connector 1200;

FIG. 11 is a cross section of the female connector 1200 with pre-mold 1240;

FIG. 12 is a schematic of the wiring of the female connector 1200 with power indicator light;

FIG. 13 is a top view of the female connector 2200;

FIG. 14 is a front view of the female connector 2200;

FIG. 15 is a cross section of the female connector 2200; and,

FIG. 16 is a schematic of the wiring of the female connector 2200.

In the figures, the following components are identified by the associated reference numeral:

| | |
|---|---|
| extension cord | 1000 |
| hot conductor | 1010 |
| neutral conductor | 1011 |
| ground conductor | 1012 |
| jacket | 1020 |
| hot insulation | 1030 |
| neutral insulation | 1031 |
| ground insulation | 1032 |
| male plug | 1100 |
| hot male blade | 1110 |
| neutral male blade | 1111 |
| ground male blade | 1112 |
| male body | 1120 |
| ground continuity indicator light | 1150 |
| female connector | 1200 |
| hot female contact | 1210 |
| neutral female contact | 1211 |
| ground female contact | 1212 |
| female body | 1220 |
| power indicator light | 1250 |
| extension cord | 2000 |
| female connector | 2200 |
| hot female contact | 2210 |
| neutral female contact | 2211 |
| ground female contact | 2212 |
| female body | 2220 |
| power indicator light | 2250 |

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFFERED EMBODIMENTS

Disclosed is a flexible extension cord with a power indicator in the female receptacle and a ground continuity indicator in the male receptacle. Preferably, the male plug may be coupled to the female connector of a power source. Suitably, the female connector may have one or more sockets for connecting to the male plug of an electronic device. The more specific aspects of the cord are disclosed in connection with the FIGURES.

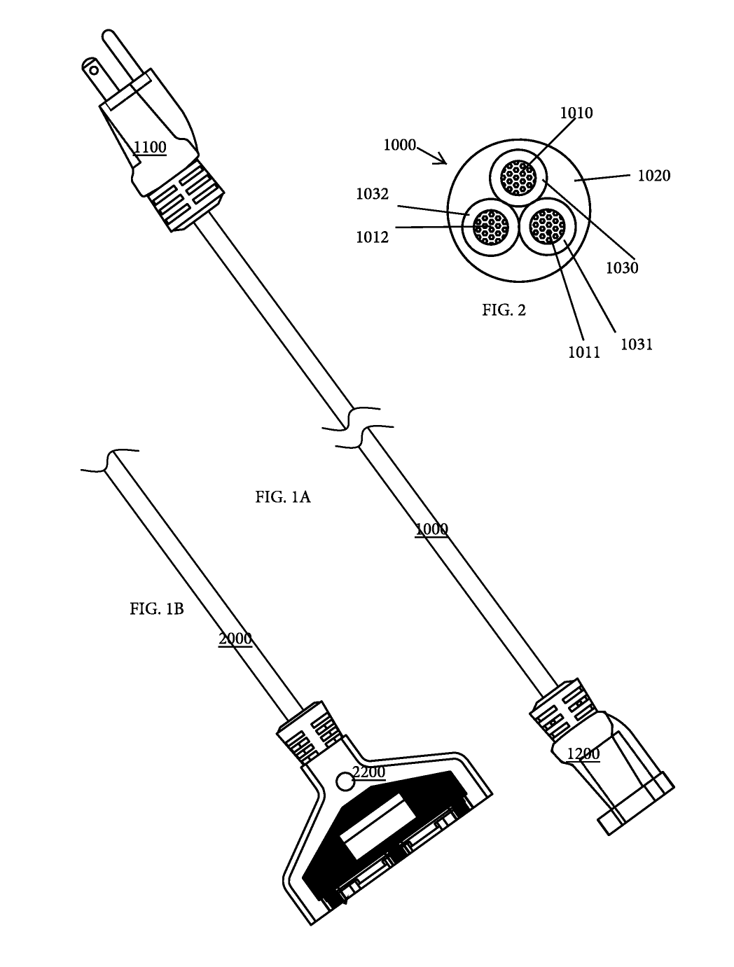

FIG. 1A is a side view of an extension cord 1000. As shown, the cord 1000 features a male plug 1100 on one end. The cord 1000 also features a female connector 1200 on the other end.

FIG. 2 is a cross section of the extension cord 1000. The cord features three electrical conductors, namely: a hot electrical conductor 1010; a neutral electrical conductor 1011; and a ground electrical conductor 1012. Each conductor 1010/1011/1012 features insulation 1030/1031/1032. Finally, the insulated conductors 1010/1011/1012 are housed in a jacket 1020.

Suitably, the cord 1000 is flexible and resistant to extreme temperatures. As such, the cord 1000 may be constructed of flexible and flame retardant material.

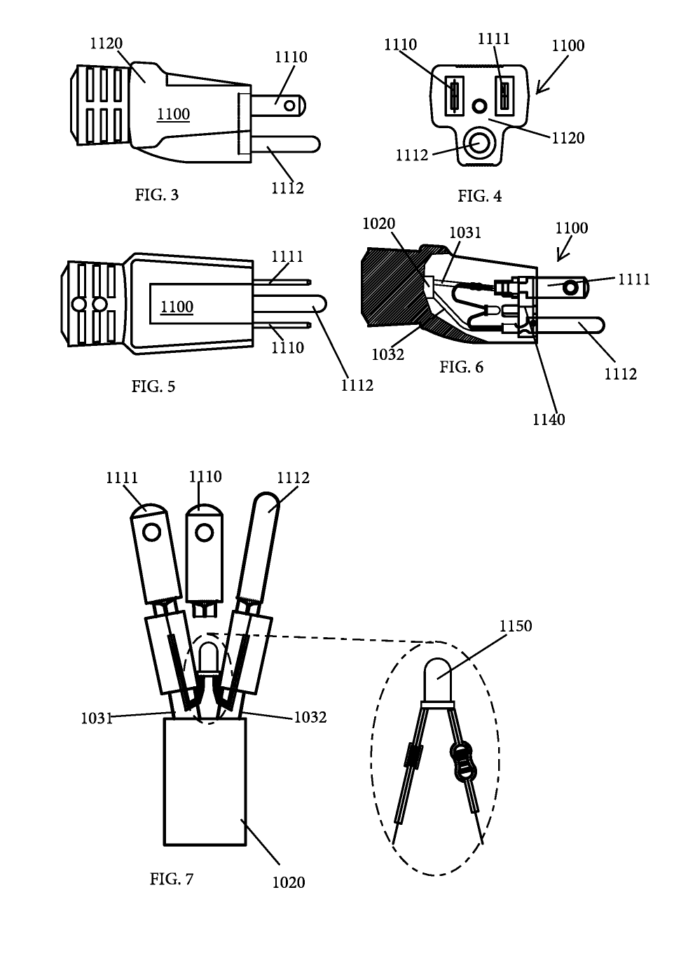

FIG. 3 is a side view of the male plug 1100. FIG. 4 is a front view of the male plug 1100. FIG. 5 is a top view of the male plug 1100. As shown, the male plug 1100 features a body 1120 from which three contacts extend, namely: the hot male blade 1110, the neutral male blade 1111, and the ground male blade 1112. In a preferred embodiment, the plug 1100 is transparent and defined by an inner transparent premold holding the blades.

FIG. 6 is a center, lengthwise cross section of the male plug 1100. FIG. 7 is a schematic of the wiring of the male plug 1100. As shown, the hot, neutral, and ground terminals or contacts 1110/1111/1112 may be electrically connected to the hot, neutral, and ground conductors 1010/1011/1012 respectively. Suitably, a ground continuity indicator light 1150 may be electrically coupled between the neutral conductor 1011 or neutral contact 1111 and the ground conductor 1012 or the ground contact 1112.

Alternatively (not shown), a ground continuity indicator light 1150 may be electrically coupled between the hot conductor 1010 or hot contact 1110 and the ground conductor 1012 or the ground contact 1112. Suitably, the ground continuity indicator light may be disposed in the body 1120 at a central location of the body 1120 behind the pre-mold 1140. In a preferred embodiment, the ground continuity indicator light 1150 may be a green colored LED light.

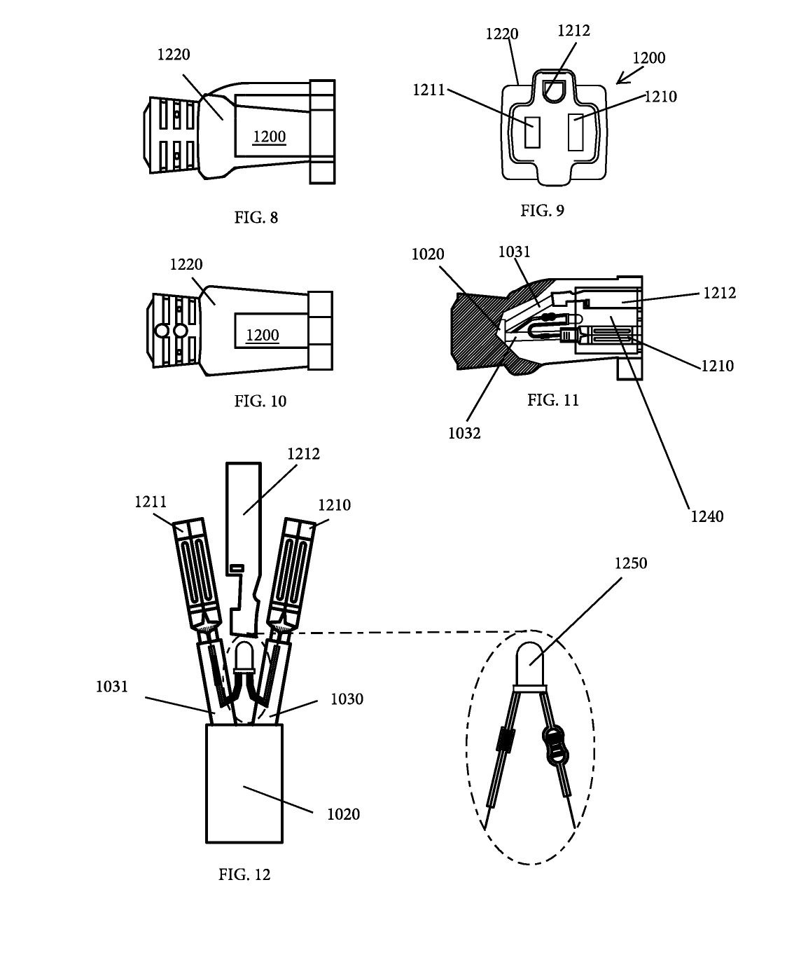

FIG. 8 is a side view of the female connector 1200. FIG. 9 is a front view of the female connector 1200. FIG. 10 is a top view of the female connector 1200. As shown, the female connector 1200 features a body 1220 within which three receptacle contacts extend, namely: the hot female contact 1210, the neutral female contact 1211, and the ground female contact 1212. In a preferred embodiment, the connector 1200 is transparent and defined by a transparent inner pre-mold 1240 holding the contacts.

FIG. 11 is a center, lengthwise cross section of the female connector 1200. FIG. 12 is a schematic of the wiring of the female connector 1200. As shown, the hot, neutral, and ground terminals or contacts 1210/1211/1212 may be electrically connected to the hot, neutral, and ground conductors 1010/1011/1012 respectively. Suitably, a power indicator light 1250 may be electrically coupled between the neutral conductor 1011 or neutral contact 1211 and the hot conductor 1010 or hot contact 1210. Suitably, the power indicator light may be disposed in the body 1220 at a central location of the body 1220 behind the pre-mold 1240. In a preferred embodiment, the ground continuity indicator light 1150 may be a blue colored LED light.

FIG. 1B is a top view of an alternate embodiment of an extension cord 2000 with a female connector 2200 at one end with a plurality of sockets. The cord 2000 suitably features a male receptacle (not shown) substantially as described above in connections with FIG. 1A and FIGS. 2 through 12. This cord 2000 is different than the cord 1000 of said figures since there are a plurality of electrical sockets in the female connector 2200, whereas the first cord 1000 only features a female connector 1200 with a single socket.

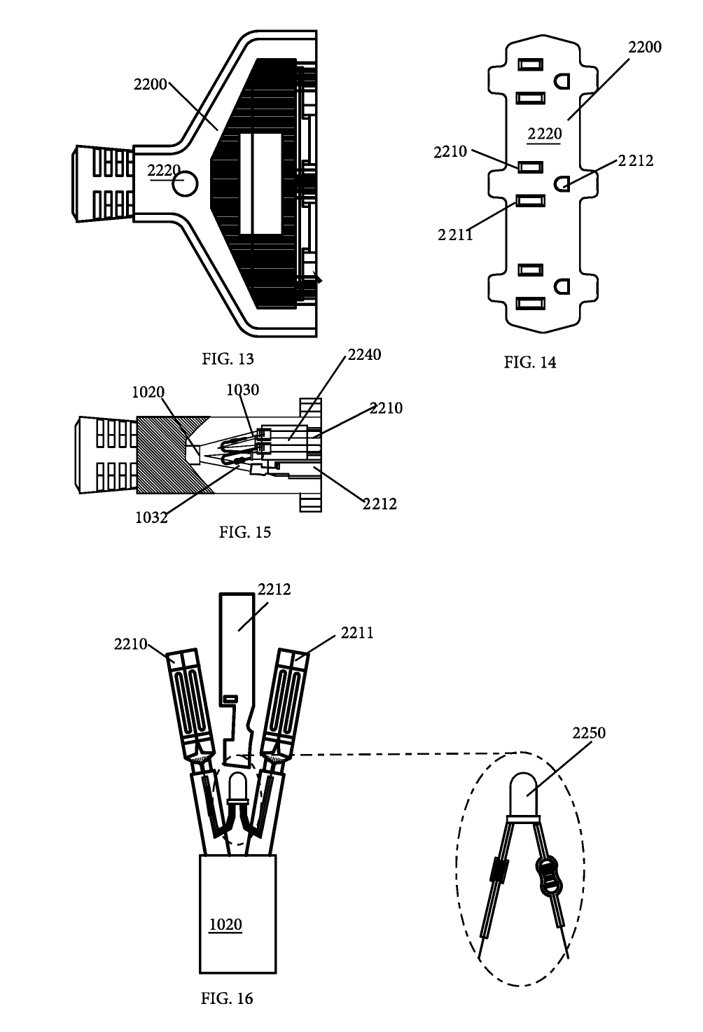

FIG. 13 is a top of the female connector 2200. FIG. 14 is a front view of the female connector 2200. FIG. 15 is a top view of the female connector 1200. As shown, the female connector 2200 features a body 2220 within which three sets of three receptacle contacts extend, namely: the hot female contact 2210, the neutral female contact 2211, and the ground female contact 2212. In a preferred embodiment, the connector 2200 is transparent and defined by a transparent inner pre-mold 2240 holding the contacts.

FIG. 15 is a center, lengthwise cross section of the female connector 2200. FIG. 16 is a schematic of the wiring of the female connector 2200. As shown, the hot, neutral, and ground terminals or contacts 2210/2211/2212 may be electrically connected to the hot, neutral, and ground conductors 2010/2011/2012 respectively. Suitably, a power indicator light 2250 or lights may be electrically coupled between the neutral conductor 1011 or neutral contact 2211 and the hot conductor 1010 or hot contact 2210. Suitably, the power indicator light 1150 or lights may be disposed in the body 2220 at a central location of the body 2220 behind the pre-mold 2240. In a preferred embodiment, the power indicator light 1150 or lights may be a colored LED light.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. An flexible extension cord with a power indicator in the female receptacle and a ground continuity indicator in the male plug.
